(19) United States
(12) Patent Application Publication
(10) Pub. No.: US 2007/0174768 A1
(43) Pub. Date: Jul. 26, 2007

(54) Adaptive alert management

(75) Inventors: Shilad W. Sen, Minneapolis, MN (US); Werner Geyer, Boston, MA (US); Michael Muller, Medford, MA (US); Martin T. Moore, Somerville, MA (US); Elizabeth A. Brownholtz, Andover, MA (US); Michael C. Wu, Vancouver (CA)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/336,231

(22) Filed: Jan. 20, 2006

(51) Int. Cl. G06F 3/00; G08B 29/00

(52) U.S. Cl. 715/700; 340/506

(57) ABSTRACT

Embodiments of the present invention address deficiencies of the art in respect to alert management and provide a method, system and computer program product for adaptive alert management. In one embodiment of the invention, an adaptive alert management data processing system can include an alert server and multiple different alert monitors disposed in corresponding application hosts. Each of the alert monitors can be configured to establish a subscription to the alert server on behalf of at least one application view of an application issuing alerts. Finally, the system can include multiple different filter rules accessible by the alert server. Each of the filter rules can specify whether or not to suppress or display an alert received in the alert server. The system further can include a data store of ratings previously applied to an alert, an established predictive rating for a target user for a received alert, and predictive alert filter logic enabled to refine the predictive rating for the received alert based upon ratings applied by a plurality of application users to the received alert in the data store.

### BACKGROUND OF THE INVENTION

1. Field of the Invention

The present invention relates to the field of alert management for computing events and more particularly to configurable alerts for computing events.

2. Description of the Related Art

Alert management in a computing system refers to the alerting of an end user through a user interface of a computing application of a computing event. Computing applications and systems often encounter computing events worth noting on the part of the end user. Historically, alerting an end user of a computing event required the suspension of an executing application and the presentation of text or a visual display notifying the end user of an alert condition. While effective in a computing environment in which only a single application can execute at a time, for multi-tasking environments, it is not reasonable to permit the interruption of all applications to present an alert.

In traditional windowing operating systems that provide multi-tasking functionality, alert management is incorporated into the operating system itself. In this regard, the operating system can provide an application programming interface (API) for invoking alerts through the operating system user interface. Often in the form of an alert box or an alert balloon, an alert can be provided by invoking a suitable operation through the alert management API. The alert itself, can be raised from a task bar or other similar such structure.

Alerts presented through the task bar of an operating system can suffice for relatively few alerts within a period of time. Notwithstanding, alerts can become intrusive where many alerts issued from multiple applications are presented repeatedly within the operating system interface. In the latter circumstance, end users may be distracted in addressing each alert. To avoid the latter circumstance, advanced alert management logic permits the configuration of the operating system to issue alerts only arising to a specified level of prioritization or importance. An alternative solution is to disable alerts entirely. In both cases, end users may not view important alerts, or otherwise end users may be compelled to view all alerts.

Advanced alert management systems rely upon non-statistical rating systems to determine whether or not to display an alert. Specifically, each alert can be assigned a rating based upon whether or not an end user had previously designated the alert as one which ought to be suppressed or viewed. The ratings, in of themselves, provide no meaning, however. Specifically, viewing a rating alone does not provide any indication as to whether or not an alert is to be suppressed or viewed. Furthermore, applying a rating system dependent only upon the assignment of a point value can be susceptible to false positives resulting in the unintended suppression of an alert.

### BRIEF SUMMARY OF THE INVENTION

Embodiments of the present invention address deficiencies of the art in respect to alert management and provide a novel and non-obvious method, system and computer program product for adaptive alert management. In one embodiment of the invention, an adaptive alert management data processing system can include an alert server and multiple different alert monitors disposed in corresponding application hosts. Each of the alert monitors can be configured to establish a subscription to the alert server on behalf of at least one application view of an application issuing alerts. Finally, the system can include multiple different filter rules accessible by the alert server. Each of the filter rules can specify whether or not to suppress or display an alert received in the alert server.

In one aspect of the invention, the system also can include a data store of ratings previously applied to an alert and predictive alert filter logic. The predictive alert filter logic can include program code enabled to provide a predictive rating for a received alert based upon ratings applied by one or more application users to the received alert in the data store. In this regard, the program code of the predictive alert filter logic can be enabled to produce a predictive rating for an alert based upon a weighted combination of ratings for the alert among the application users. For instance, the program code of the predictive alert filter logic can be enabled to apply a Bayesian model in providing the predictive rating for a received alert. More specifically, the Bayesian model can include a weighted sum of predictive ratings for the application users for a plurality of different alerts.

In another embodiment of the invention, a method for adaptive alert management can be provided. The method can include establishing a subscription to an alert for an application user of an application; receiving an alert for the application; locating a filter rule for the alert; and, applying the filter rule to the alert to determine whether or not to suppress or display the alert for the application user. In one aspect of the embodiment, the method yet further can include failing to locate a filter rule for the alert, and, responsive to failing to locate the filter rule, computing a predictive rating for the alert and determining whether or not to suppress or display the alert based upon the predictive rating.

Computing a predictive rating for the alert can include training a Bayesian model based upon multiple, different previously classified alerts for users of the application. The method further can include applying the Bayesian model to the alert to produce the predictive rating. Moreover, training a Bayesian model for a plurality of previously classified alerts for users of the application can include generating predictive equations of a weighted sum of ratings for a user for the alert, each predictive equation addressing a different alert. The method further can include performing a linear regression analysis of the predictive equations to determine weights utilized in the weighted sum.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a data processing system enabled for adaptive alert management;

FIG. 2 is a flow chart illustrating a process for adaptive alert management; and,

FIG. 3 is a flow chart illustrating a process for training a predictive alert filter for use in the adaptive alert management system of FIG. 1.

### DETAILED DESCRIPTION OF THE INVENTION

Embodiments of the present invention provide a method, system and computer program product for adaptive alert management. In accordance with an embodiment of the present invention, an adaptive alert management system can consider both filter rules established for unfiltered alerts for end users, as well as statistically derived predictive ratings for determining whether or not an alert is to be suppressed or viewed in the absence of a filter rule. Optionally, a client-server architecture can be established to support a subscription based model of alert management. In this way, alerts originating from both remote and local sources or alert feeds, can be managed uniformly by an alert management server associated with the user, according to established filter rules and predictive ratings. These filter rules and predictive ratings can be customized according to the preferences and usage history of the user.

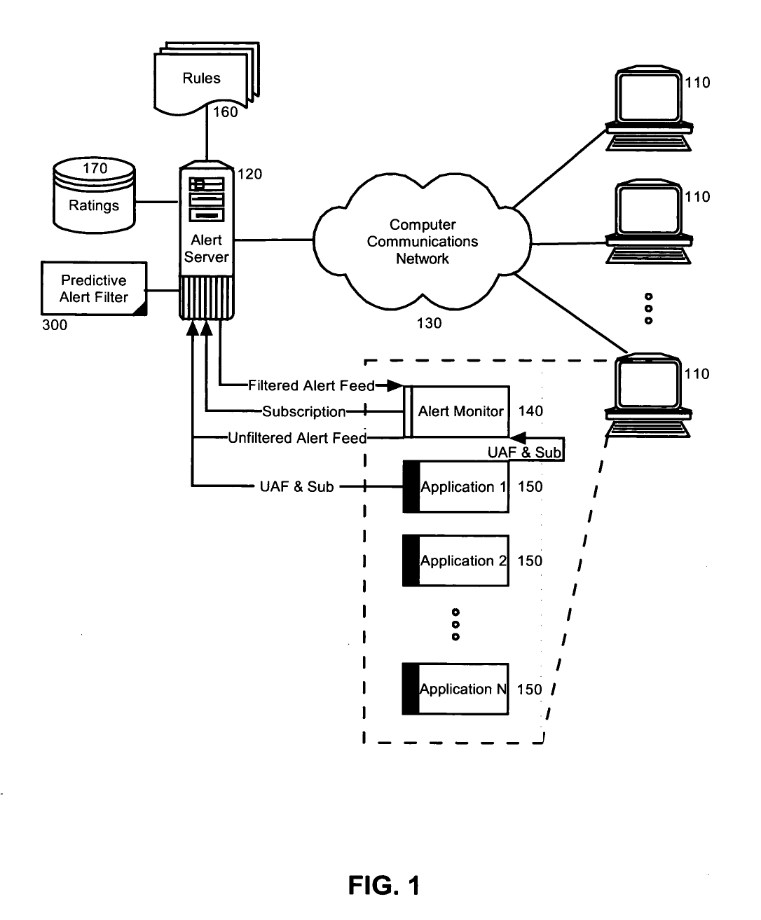

In illustration, FIG. 1 is a schematic illustration of a data processing system enabled for adaptive alert management. The data processing system can include an alert server 120 coupled to one or more application hosts 110 over a computer communications network 130. Each of the application hosts 110 can host one or more application views 150 to corresponding applications, such as those hosted locally, or those provided by an application server in a composite aggregation environment. Each of the application hosts 110 further can include an alert monitor 140. The alert monitor 140 can include program code enabled to subscribe to one or more alerts in the alert server 120 on behalf of one or more of the applications associated with the application views 150. The alert server 120 can also subscribe directly to alert feeds from an application host 100. In one aspect of the invention, the subscription can be that of a subscription of a really simple syndication (RSS) compliant feed or an Atom compliant feed.

The alert server 120 can include both a set of filter rules 160 for one or more alerts defining whether to suppress or display a respective unfiltered alert, and a data store of statistical ratings 170 for previously filtered alerts. Importantly, predictive alert filter logic 300 can be coupled to the alert server 120. The predictive alert filter logic 300 can include program code enabled to train the prediction of an alert filter for an unfiltered alert based upon the statistical ratings 170 for previously filtered alerts. Utilizing the predictive alert filter 300, it can be predicted whether or not to filter an unfiltered alert without exclusively relying upon the presence of a static filter rule for the unfiltered alert. In fact, the ratings 170 produced by the predictive alert filter 300 can be used to statistically determine whether or not to suppress or display an alert even in the complete absence of a static filter rule for the unfiltered alert.

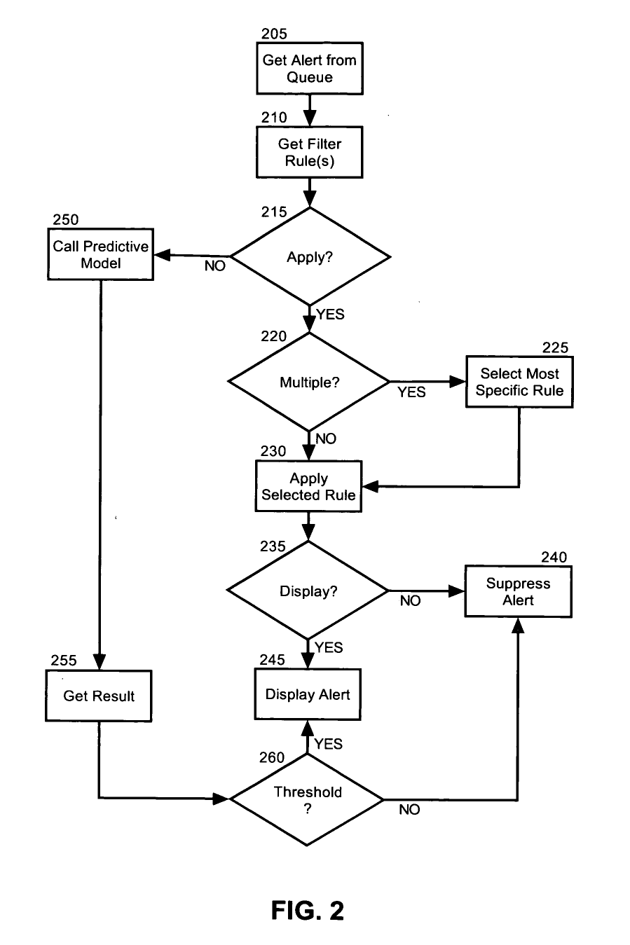

In operation, the alert monitor 140 within an application host 110 can subscribe to an alert on behalf of an application and corresponding one of the application views 150 with the alert server 120. The alert server 120, in turn, can process incoming alerts from the alert monitor 140 in order to determine whether or not to render an alert for the corresponding one of the application views 150. The alert server 120 can also process alerts that are transmitted directly from an application view 150 on a remote application host 110 as shown in FIG. 1. To manage the receipt of a multiplicity of alerts, an alert queue (not shown) can be established to queue unfiltered alerts prior to adaptively managing the processing of the unfiltered alerts. In further illustration, FIG. 2 is a flow chart illustrating a process for adaptive alert management in the data processing system of FIG. 1.

Beginning in block 205, an alert can be retrieved from the alert queue. In block 210, zero or more filter rules can be retrieved for the alert for the application. The filter rules can specify when to suppress or display an alert and can range from the nature of the application issuing the alert, the time of day, the priority or urgency of an alert, or the textual content of the alert, to name only a few. In decision block 215, it can be determined whether a filter rule can be located for the alert. If so, the process can proceed in decision block 220. Otherwise, the process can continue with the invocation of a predictive model in block 250. Utilizing the predictive model, in block 255 a rating can be obtained which can be compared to a threshold value. In decision block 260, if the rating does not exceed the threshold value, in block 240, the alert can be suppressed. Otherwise, in block 245 the alert can be displayed.

Presuming that at least one filter rule can be retrieved for the alert, in decision block 220, it can be determined whether multiple filter rules have been retrieved for the alert. If so, the most specific of the filter rules can be selected for application in block 225. Subsequently, in block 230, the selected filter rule (or singularly retrieved filter rule as the case may be) can be applied to the unfiltered alert. In decision block 235, it can be determined whether the action associated with the applied filter rule requires the suppression or display of the alert. Accordingly, in block 240, the alert can be suppressed if mandated by the action, or in block 245 the alert can be displayed if mandated by the action. Optionally, suppressed alerts can be stored for review through a management interface.

Advantageously, the statistical nature of the predictive model of block 250 can be used to accurately predict whether or not to display or suppress an alert, even in the absence of an existing filter rule for the alert. In this regard, the predictive model of block 250 can implement a collaborative approach to Bayesian modeling to classify an unfiltered alert as one that is to be displayed or suppressed. The Bayesian modeling aspect of the predictive model of block 250 can consider the historical rating of an alert by other subscribers to the alert. The Bayesian modeling aspect of the predictive model of block 250 can classify an alert according to its attributes which can include the issuing application, the content of the alert (the words, for instance), and information derived from the alert such as how many alerts have been recently received by the recipient.

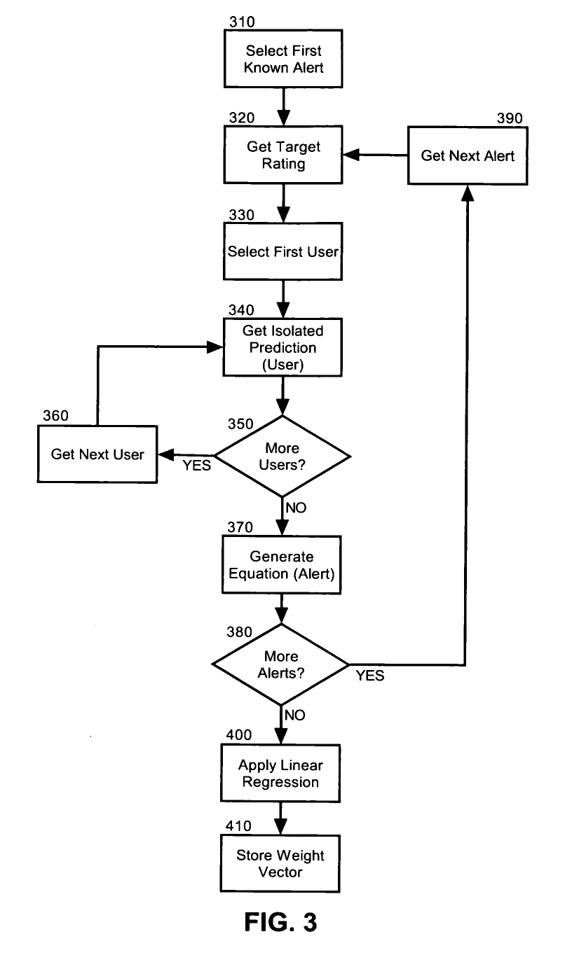

The predictive model 250 can be bifurcated into a training process and a prediction process. When training a predictive alert filter, first a predictive model 250 can be calculated for an alert for a target user, and subsequently the predictive model 250 can be refined based upon data accumulated for other users receiving the same alert. In this regard, FIG. 3 is a flow chart illustrating a process for training a predictive alert filter for use in the adaptive alert management system of FIG. 1. Beginning in block 310, a first known alert can be selected for processing. In block 320, a target rating can be obtained for the first known alert. In block 330, a first user can be identified for the first known alert and in block 340, an isolated prediction for the first known alert can be obtained. In decision block 350, if additional users remain to be considered, in block 360, a next user can be retrieved and the process can continue through block 340 until no further users remain to be considered for the first known alert.

In block 370, when no further users remain to be considered for the first known alert, an equation can be generated for the first known alert. The equation can take the form of “r(target, a₁)=w₁*p(u₁, a₁)+w₂*p(u₂, a₁)+ . . . +wₙ*p(uₙ, a₁)” where “r(target, a₁)” is the rating applied to the first known alert for the target user, p(uₓ, a₁) is the rating applied to the first known alert by each user for “x” number of users, and where wₓ is the vector of weights to be applied to the rating on a user by user basis for users 1 through “x”. Importantly, the process can repeat for a set of alerts leading through decision block 380 and block 390.

In decision block 380, when no additional alerts remain to be considered, a set of equations will have been produced according to

$$r ( {user}_{tar} , {alert}_{y} ) = {\sum }_{x = 1 , y = 1}^{x = n , y = m} {w}_{x} p ( {user}_{x} , {alert}_{y} )$$

As such, in block 400 a linear regression analysis can be applied to compute values for each weight in the vector wₓ. It is to be recognized by the skilled artisan, then, that the weights in the vector wₓ change over time based upon the ratings of the target user and the other users and, in this sense, is adaptive. In any event, in block 410, the weight vector can be stored for use during the predictive analysis for an incoming alert

It will be recognized by the skilled artisan that the use of a linear regression analysis can minimize the squared error between the collaborative prediction of the userₓ and the target user, userₜₐᵣ. Notwithstanding, to address potential overfitting of the predictive model to the data set of previous predictive ratings, user-specific bayesian models can be established as a weighted combination of the global bayesian model for an attribute of an alert, and an individualized bayesian model for the attribute. In this way, as a user collects more ratings for an attribute of an alert, the weighting can be increased for the user-based model relative to the global model. Also, to avoid overfitting the regression equation, a set of equations for “artificial alerts” can be generated and incorporated into the regression equation with random values for each prediction in the equations for the artificial alerts.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. An adaptive alert management data processing system comprising:
an alert server;
a plurality of alert monitors disposed in corresponding application hosts, each of the alert monitors being configured to establish a subscription to the alert server on behalf of at least one application view of an application issuing alerts; and,
a plurality of filter rules accessible by the alert server, each of the filter rules specifying whether or not to suppress or display an alert received in the alert server.

2. The system of claim 1, further comprising:
a data store of ratings previously applied to an alert;
an established predictive rating for a target user for a received alert; and,
predictive alert filter logic comprising program code enabled to refine the predictive rating for the received alert based upon ratings applied by a plurality of application users to the received alert in the data store.

3. The system of claim 1, wherein the subscription comprises a syndicated feed selected from the group consisting of a really simple syndication (RSS) feed and an Atom feed.

4. The system of claim 2, wherein the program code of the predictive alert filter logic is enabled to refine the predictive rating for an alert based upon a weighted combination of ratings for the alert among the application users.

5. The system of claim 2, wherein the program code of the predictive alert filter logic is enabled to apply a Bayesian model in refining the predictive rating for a received alert.

6. The system of claim 5, wherein the Bayesian model comprises a weighted sum of predictive ratings for the application users for a plurality of different alerts.

7. The system of claim 5, wherein the Bayesian model further comprises a weighted sum of predictive ratings for the application users for at least one artificial alert.

8. A method for adaptive alert management, the method comprising:
establishing a subscription to an alert for an application user of an application;
receiving an alert for the application;
locating a filter rule for the alert; and,
applying the filter rule to the alert to determine whether or not to suppress or display the alert for the application user.

9. The method of claim 8, wherein establishing a subscription to an alert for an application user of an application, comprises establishing a syndicated feed to an alert for an application user of an application.

10. The method of claim 8, wherein receiving an alert for the application comprises queueing the alert in a queue of unfiltered alerts.

11. The method of claim 8, wherein locating a filter rule for the alert, comprises:
locating a plurality of different filter rules of varying specificity; and,
selecting a most specific one of the different filter rules for application to the alert.

12. The method of claim 8, further comprising:
failing to locate a filter rule for the alert; and,
responsive to failing to locate the filter rule, computing a predictive rating for the alert and determining whether or not to suppress or display the alert based upon the predictive rating.

13. The method of claim 12, wherein computing a predictive rating for the alert comprises:
training a Bayesian model for a plurality of previously classified alerts for a target user of the application and for a plurality of users of the application; and,
applying the Bayesian model to the alert to produce the predictive rating.

14. The method of claim 13, wherein training a Bayesian model for a plurality of previously classified alerts for a plurality of users of the application, comprises:
generating a plurality of predictive equations of a weighted sum of ratings for a user for the alert, each predictive equation addressing a different alert; and,
performing a linear regression analysis of the predictive equations to determine weights utilized in the weighted sum.

15. A computer program product comprising a computer usable medium having computer usable program code for adaptive alert management, the computer program product including:
computer usable program code for establishing a subscription to an alert for an application user of an application;
computer usable program code for receiving an alert for the application;
computer usable program code for locating a filter rule for the alert; and,
computer usable program code for applying the filter rule to the alert to determine whether or not to suppress or display the alert for the application user.

16. The computer program product of claim 15, wherein the computer usable program code for establishing a subscription to an alert for an application user of an application, comprises computer usable program code for establishing a syndicated feed to an alert for an application user of an application.

17. The computer program product of claim 15, wherein the computer usable program code for receiving an alert for the application comprises computer usable program code for queueing the alert in a queue of unfiltered alerts.

18. The computer program product of claim 15, wherein the computer usable program code for locating a filter rule for the alert, comprises:
computer usable program code for locating a plurality of different filter rules of varying specificity; and,
computer usable program code for selecting a most specific one of the different filter rules for application to the alert.

19. The computer program product of claim 15, further comprising:
computer usable program code for failing to locate a filter rule for the alert; and,
computer usable program code for responsive to failing to locate the filter rule, computing a predictive rating for the alert and determining whether or not to suppress or display the alert based upon the predictive rating.

20. The computer program product of claim 19, wherein computing a predictive rating for the alert comprises:
computer usable program code for training a Bayesian model for a plurality of previously classified alerts for target user of the application and for a plurality of users of the application; and,
computer usable program code for applying the Bayesian model to the alert to produce the predictive rating.

21. The computer program product of claim 20, wherein the computer usable program code for training a Bayesian model for a plurality of previously classified alerts for a plurality of users of the application, comprises:
computer usable program code for generating a plurality of predictive equations of a weighted sum of ratings for a user for the alert, each predictive equation addressing a different alert; and,
computer usable program code for performing a linear regression analysis of the predictive equations to determine weights utilized in the weighted sum.
